(19) United States
(12) Patent Application Publication
(10) Pub. No.: US 2026/0329151 A1
(43) Pub. Date: Oct. 22, 2026

(54) SOFTBOX AND CHUCK THEREOF

(71) Applicant: Shaoxing Shangyu Lifei Photographic Equiqment Co., Ltd., Shaoxing (CN)

(72) Inventor: Lifei SHEN, Shaoxing (CN)

(21) Appl. No.: 19/649,133

(22) Filed: Apr. 16, 2026

(30) Foreign Application Priority Data
Apr. 21, 2025 (CN) 202520786557.6

(51) Int. Cl. G03B 15/06

(52) U.S. Cl. CPC G03B 15/06

(57) ABSTRACT

Disclosed are a softbox and a chunk. The chunk includes a chunk body, an adapter, first and second connecting members, and a locking member. The adapter is rotatably assembled to the chunk body, and has an unfolded state and a folded state. The first and second connecting members are configured for connecting support rods of the softbox. The first connecting members are movably connected to the chunk body, and the second connecting members are connected to the adapter. The first and second connecting members extend radially in the unfolded state. A number of the second connecting members is less than half of a total number of the first and second connecting members. An orientation of the second connecting member in the unfolded state is opposite to that in the folded state. The locking member is configured for locking the adapter in the unfolded state.

### CROSS-REFERENCE TO RELATED APPLICATIONS

The present application claims priority of Chinese Patent Application No. 202520786557.6, filed on Apr. 21, 2025, the entire contents of which are hereby incorporated by reference.

### TECHNICAL FIELD

The present application relates to the technical field of photographic equipment, and in particular to a softbox chuck and a softbox.

### BACKGROUND

The existing softbox chuck, such as a quick-lock softbox chuck and softbox disclosed in CN221406298U, includes an umbrella-shaped chuck seat, on which a plurality of first and second support seats are movably connected. There are two second support seats, each rotatably connected to the umbrella-shaped chuck seat. In order to improve synchronization, a linkage part is connected between the two second support seats. During assembling, the two second support seats need to be rotatably connected to the umbrella-shaped chuck seat, and the two second support seats are at a certain angle to each other and far away from each other, which places certain requirements on the assembly between components and the machining accuracy of each component.

### SUMMARY

An object of the present application is to provide a softbox chuck that improves assembly efficiency.

The present application provides a softbox chuck, including:
a chunk body;
an adapter being rotatably assembled to the chunk body, wherein the adapter has an unfolded state and a folded state;
a plurality of connecting members configured for connecting support rods of the softbox, wherein the plurality of connecting members includes multiple first connecting members being movably connected to the chunk body and multiple second connecting members being connected to the adapter; the plurality of connecting members extend radially when the adapter is in the unfolded state, a number of the second connecting members is less than half of a total number of the plurality of connecting members, and an orientation of the second connecting member when the adapter is in the unfolded state is opposite to that of the second connecting member when the adapter is in the folded state; and
a locking member configured for locking the adapter in the unfolded state.

In some embodiments, the adapter includes a connecting portion that is rotatably connected to the chunk body and a mounting portion that fixes the second connecting member.

In some embodiments, the chunk body is configured with a recessed area, and when the adapter is in the unfolded state, the mounting portion is located in the recessed area and flushes with an outer circumferential surface of the chunk body, and the second connecting member protrudes out from the mounting portion.

In some embodiments, the adapter includes a first holding portion, and the chunk body includes a second holding portion arranged opposite to the first holding portion.

In some embodiments, the first holding portion extends between adjacent two second connecting members, and a gap is defined between the first holding portion and the mounting portion.

In some embodiments, the locking member includes a locking portion and is slidably mounted to the chunk body, and has a locking state in which the locking portion is engaged with the mounting portion and an unlocking state in which the locking portion is disengaged from the mounting portion.

In some embodiments, the locking member includes an unlocking portion.

In some embodiments, the locking member is slidable in a radial direction, and the unlocking portion is exposed outside an outer circumferential surface of the chunk body.

In some embodiments, the unlocking portion extends in a radial direction, the locking portion extends in an axial direction, and the mounting portion is configured with a locking hole that matches the locking portion.

In some embodiments, the chunk further includes a first reset member acting on the locking member to keep it in a locking state.

In some embodiments, the first connecting members are close to a middle position of the chunk body when the adapter is in the folded state.

In some embodiments, the chunk body is configured with a limiting groove extending along a circumferential direction, and the limiting groove is configured for limiting a motion trajectory of the first connecting member.

In some embodiments, the chunk further includes a second reset member acting on the first connecting member closest to the adapter to make it swing and unfold.

In some embodiments, there are two second connecting members.

In some embodiments, there are six first connecting members.

In some embodiments, the first connecting member includes a mounting portion that cooperates with the chunk body in a rotatable manner, and a fixed portion that is fixed with the support rod by plug-in, the mounting portion is spherical-shaped, and the fixed portion is cylindrical-shaped and configured with a socket.

The present application also provides a softbox, including:
the above chuck;
a plurality of support rods connected to the first connecting members and the second connecting members; and
a reflective cloth supported by the plurality of support rods.

For the present softbox chuck, the second connecting members are rotatably connected to the chunk body through the adapter. Compared with the softbox chunk in the art, it eliminates the connection between each second connecting member and the umbrella-shaped chunk body, reducing the requirement for assembly accuracy and the number of assembly times, thereby improving assembly efficiency.

### BRIEF DESCRIPTION OF THE DRAWINGS

FIG. 1 is a schematic view of a softbox according to an embodiment of the present application.

FIG. 2 is a schematic view of a chuck in an unfolded state according to an embodiment of the present application.

FIG. 3 is a schematic view of the chuck of FIG. 2 from another aspect.

FIG. 4 is a schematic view of chuck of FIG. 2 when its adapter switched to a folded state.

FIG. 5 is a top view of the chuck of an embodiment of the present application after an upper chunk being removed.

FIG. 6 is an exploded view of the chuck of FIG. 2.

### REFERENCE NUMBERS IN THE DRAWINGS

100, chunk body; 110, upper chunk; 120, lower chunk; 121, connecting base; 130/130a, limiting groove; 140, first reset member; 141, second reset member; 1411, first action arm; 1412, second action arm; 143, mounting groove; 151, first recessed area; 152, second recessed area; 160, second holding portion;
200, adapter; 210, connecting portion; 211, shaft; 220, assemble portion; 221, latching slot; 230, first holding portion; 231, gap;
310/310a, first connecting member; 311, mounting portion; 312, fixed portion; 320, second connecting member;
400, locking member; 410, locking portion; 420, unlocking portion;
500, support rod;
600, reflective cloth;
700, attachments.

### DESCRIPTION OF THE EMBODIMENTS

Technical solutions of embodiments of the present application will be clearly and completely described below with reference to the accompanying drawings. Obviously, the described embodiments are only some embodiments of the present application, not all of them. Based on the embodiments of this application, all other embodiments obtained by those ordinary skilled in the art without creative labor are within the scope of protection of this application.

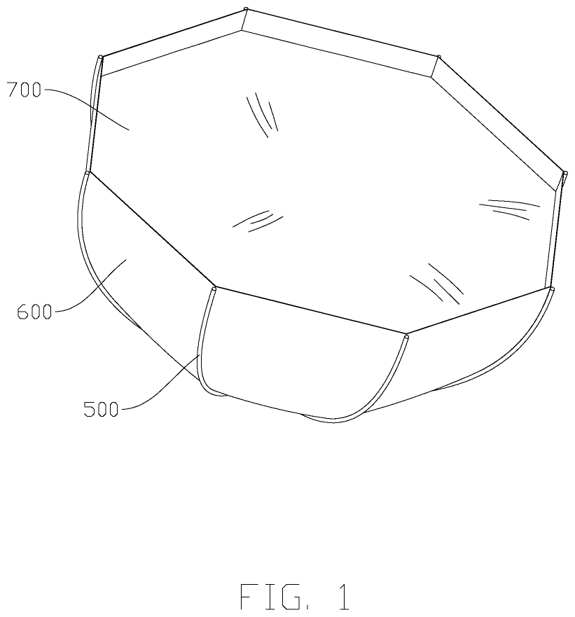

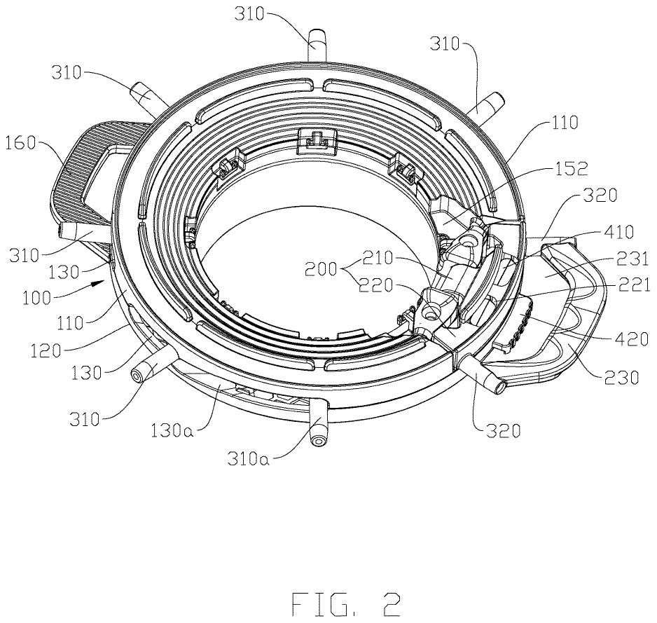

Referring to FIGS. 1-2, a softbox includes a softbox chuck (hereinafter referred to as chuck), a plurality of support rods 500, and a reflective cloth 600. The support rods 500 are mounted on the chuck, and the reflective cloth 600 is supported by the support rods 500. The reflective cloth 600 has an inner surface and an outer surface, wherein the inner surface is provided with a reflective layer that reflects light.

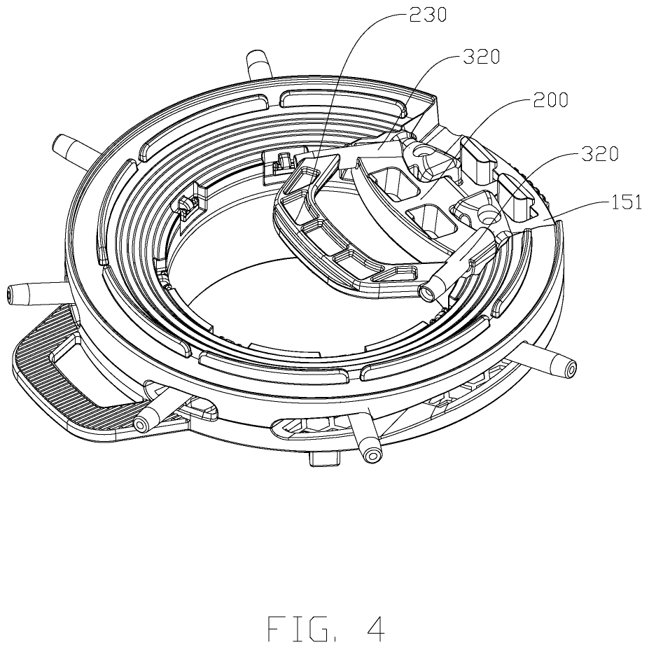

As shown in FIGS. 2-5, the present application also provides a softbox chuck (hereinafter referred to as chuck), including a chunk body 100, an adapter 200, a plurality of connecting members, and a locking member 400. The chunk body 100 is an annular structure, with an axial direction and corresponding radial and circumferential directions. The adapter 200 is rotatably assembled onto the chunk body 100, and has an unfolded state as shown in FIG. 2 and a folded state as shown in FIG. 4.

The plurality of support rods 500 are respectively connected to the plurality of connecting members, for example, one end of each support rod 500 is fixedly inserted into one corresponding connecting member. The plurality of connecting members include multiple first connecting members 310 and multiple second connecting members 320, wherein a number of the second connecting members 320 is less than half of a total number of the plurality of connecting members. The number of first connecting members 310 may be adaptively selected according to need. For example, as shown As shown in the drawings, there are six first connecting members 310 that are evenly arranged along the circumferential direction of the chunk body 100, while there are two second connecting members 320.

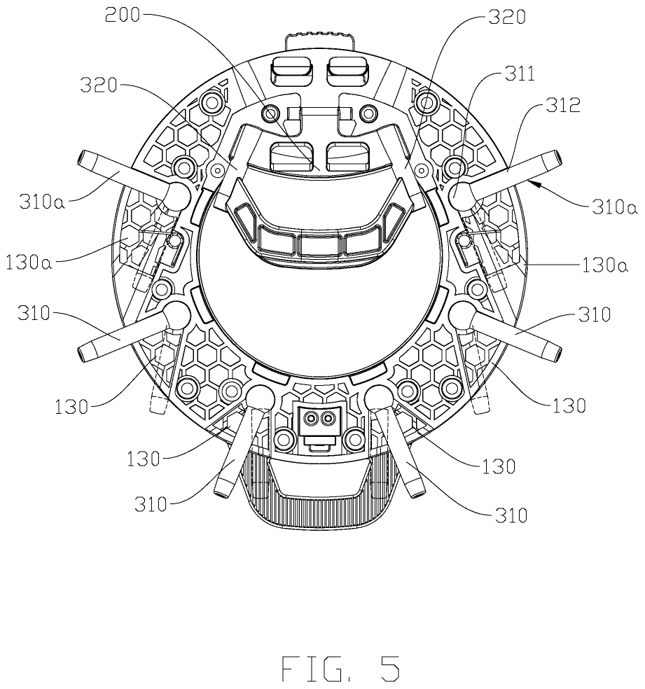

The first connecting member 310 is movably connected to the chunk body 100, and the second connecting member 320 is connected to the adapter 200. In actual use, as shown in FIG. 5, when the adapter 200 is in the folded state, the first connecting members 310 move under the pulling of the reflective cloth 600, approaching a middle position of the chunk body 100 and finally extending towards the same side (as shown by the dashed lines and solid lines in FIG. 5). The second connecting members 320 and the first connecting members 310 are orientated towards the same side, and the reflective cloth 600 is folded to make the softbox be flat, thereby being easy to store. When the adapter 200 is rotated to the unfolded state, the orientation of the second connecting member 320 is opposite to that in the folded state, and the reflective cloth 600 is unfolded. At the same time, the unfolded reflective cloth 600 pulls the first connecting members 310 to move. Finally the first connecting members 310 and the second connecting members 320 extend radially, and the reflective cloth 600 is stretched open to form a cage-shaped cover, wherein the light is emitted outwardly from the opening of the cover. Attachments, such as soft cloth, grille 700 and the like may be installed at the opening of the cover.

For the softbox chuck of the present application, the second connecting members are rotatably connected to the chunk body through the adapter. Compared with the softbox chunk in the art, it eliminates the connection between each second connecting member and the umbrella-shaped chunk body, reducing the requirement for assembly accuracy and the number of assembly times, thereby improving assembly efficiency.

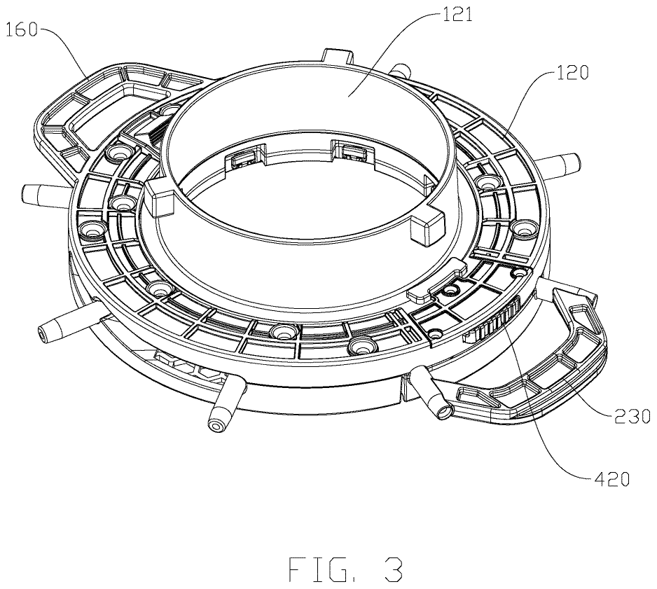

As shown in FIG. 3, in one embodiment, the chunk body 100 includes an upper chunk 110 and a lower chunk 120 that are fixedly connected in the axial direction by fasteners such as screws or bolts. The chunk body 100 is provided with a central hole for inserting of a photography lamp, and the lower chunk 120 is provided with a connecting seat 121 for installing the photography lamp. For easy storage, the connecting seat 121 and the lower chunk 120 are detachably connected.

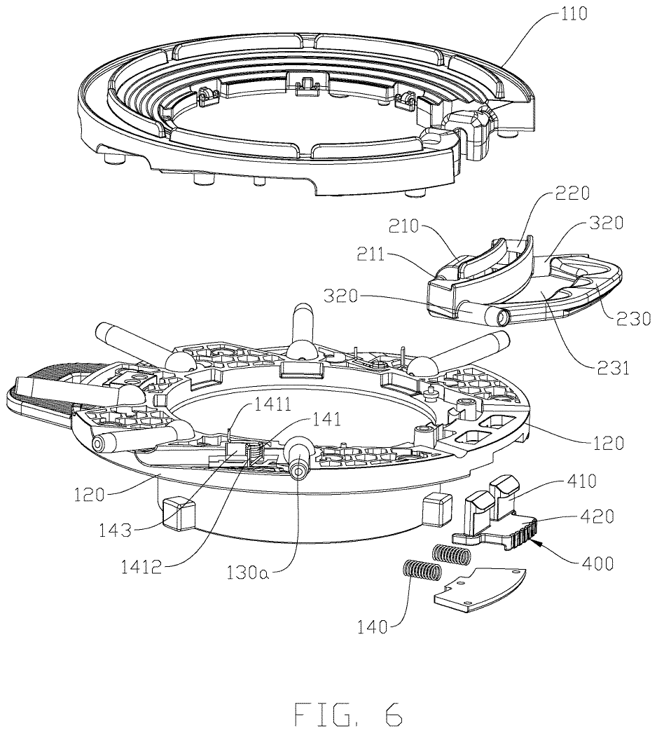

As shown in FIGS. 5-6, the first connecting member 310 includes a mounting portion 311 that cooperates with the chunk body 100 in a rotatable manner, and a fixed portion 312 that is fixed to the support rod 500 by plug-in. The mounting portion 311 is spherical-shaped, and the fixed portion 312 is cylindrical-shaped and configured with a socket. The upper chunk 110 defines a first mounting chamber, and the lower chunk 120 defines a second mounting chamber. When the upper chunk 110 and the lower chunk 120 are fixedly connected together, the first mounting chamber and the second mounting chamber cooperatively form a chamber that matches the mounting portion 311, wherein the first connecting member 310 can rotate around a center of the spherical-shaped mounting portion 311. In one embodiment, the chunk body 100 defines a limiting groove 130 extending along the circumferential direction for each first connecting member 310. The limiting groove 130 is configured for limiting a motion trajectory of the corresponding first connecting member 310. The extension directions of the limiting grooves 130 are not strictly limited to the radial plane, and the extension lengths of the limiting grooves 130 may be the same or different.

In one embodiment, starting from the adapter 200, the extension length of the limiting groove 130 gradually decreases, that is, two limiting grooves 30a closest to the adapter 200 have the longest extension length, and the limiting groove 130 farthest from the adapter 200 has the shortest extension length.

Due to the long extension length of the limiting groove 30a, there may be a problem of unsmooth swinging of the corresponding first connecting member 310a during the unfolding process due to friction and other reasons. Blindly unfolding may cause damage to the support rods 500 or the reflective cloth 600. In one embodiment, the chuck includes a second reset member 141 that acts on the first connecting member 310a to make it swing and unfold. As shown in FIG. 6, the chunk body 100 defines a mounting groove 143 that communicates with the limiting groove 30a, and the second reset member 141 is a torsion spring set in the mounting groove 143a. The second reset member 141 includes a first action arm 1411 and a second action arm 1412. The first action arm 1411 is located in the mounting groove 143 and abuts against the chunk body 100. The second action arm 1412 extends into the limiting groove 30a. During folding of the softbox, the reflective cloth 600 pulls the first connecting member 310a to swing and thus compresses and twists the second action arm 1412 of the second reset member 141. During unfolding of the softbox, the reflective cloth 600 pulls the first connecting member 310a, while the second action arm 1412 twists and resets to assist the reflective cloth 600 in driving the first connecting member 310a to swing.

To avoid improper folding and swinging of the first connecting member 310a during folding of the softbox, the stiffness of the second reset member 141 may be reduced. Alternatively, in one embodiment, in the unfolding state, the second action arm 1412 and the first connecting member 310a are spaced from each other.

As shown in FIG. 2 and FIG. 6, in one embodiment, the adapter 200 includes a connecting portion 210 that is rotatably connected to the chunk body 100, an assemble portion 220 that fixes the second connecting member 320, and a first holding portion 230 that extends between two adjacent second connecting members 320. A gap 231 is defined between the first holding portion 230 and the assemble portion 220, which facilitates holding of the first holding portion 230 by one hand. The second connecting member 320 protrudes out from and is integrally formed with the assemble portion 220. The first holding portion 230 is generally a U-shaped plate with anti-slip patterns formed on its outer surface.

The assemble portion 220 extends along the circumferential direction to connect the second connecting members 320, and the connecting portion 210 is arranged in a middle of the assemble portion 220 and is recessed in the circumferential direction relative to the assemble portion 220. Two sides of the connecting portion 210 in the circumferential direction are protruded with shafts 211, and the chunk body 100 is provided with shaft holes adapted to receive the shafts 211. For ease of assembly, the upper chunk 110 and the lower chunk 120 are connected to each other to form the shaft holes.

Furthermore, the chunk body 100 includes a second holding portion 160 arranged opposite to the first holding portion 230. As shown in the drawings, the second holding portion 160 is generally a U-shaped plate and is fixedly connected to the lower chunk 120. During unfolding of the softbox, one hand holds the second holding portion 160, and the other hand holds the first holding portion 230.

As shown in FIG. 2 and FIG. 4, the chunk body 100 is provided with a first recessed area 151, and the assemble portion 220 is located in the first recessed area 151 and flushes with an outer circumferential surface of the chunk body 100. The chunk body 100 may also provided with a second recessed area 152. In the folded state, the assemble portion 220 is partially located within the second recessed area 152. Among them, the adapter 200 rotates approximately 180 degrees from the unfolded state to the folded state. As shown in the drawings, the upper chunk 110 is provided with a notch which serves as the first recessed area 151 and a slot which serves as the second recessed area 152.

In order to keep the softbox in the unfolded state for normal use, the locking member 400 can lock the adapter 200 to maintain it in the unfolded state, thereby keeping the reflective cloth 600 unfolded. The chuck also includes an unlocking member for unlocking the locking member 400.

As shown in FIG. 6, in one embodiment, the locking member 400 includes a locking portion 410 and an unlocking portion 420 for unlocking the locking member 400, that is, the locking member 400 also serves as the unlocking member. The locking member 400 slides radially to be installed onto the lower chunk 120, and has a locking state in which the locking portion 410 is engaged with the assemble portion 220, and a unlocking state in which the locking portion 410 is disengaged from the assemble portion 220. For the convenience of unlocking operation, the unlocking portion 420 is exposed outside the outer circumferential surface of the lower chunk 120.

As shown in the drawings, the locking member 400 is generally L-shaped, wherein the locking portion 410 includes two hooks extending along the axial direction, and the unlocking portion 420 extends radially with anti-slip patterns formed on its end surface. The assemble portion 220 is provided with latching slots 221 that match with the hooks. In the unfolded state, the unlocking portion 420 is located below the first holding portion 230. During folding of the softbox, the unlocking portion 420 is pushed to slide radially and inwardly, making the hooks disengage from the latching slots 221. The reflective cloth 600 and the support rods 500 are folded to release stress and drive the adapter 200 to rotate and fold.

In one embodiment, as shown in FIG. 6, the chuck further includes a first reset member 140 acting on the locking member 400 to maintain it in the locked state. The first reset member 140, for example, is a spring and disposed within the lower chunk 120.

For the softbox chuck of this application, the second connecting member is connected to the chunk body through the adapter. Compared to softbox chuck in the art, it eliminates the connection between the second connecting member and the umbrella-shaped chunk body, reduces the requirement for assembly accuracy and the number of assembly times, thereby improving assembly efficiency.

The technical features of the above embodiments may be combined in any way. In order to make the description concise, not all possible combinations of the technical features in the above embodiments have been described. However, as long as there is no contradiction in the combination of these technical features, they should be considered within the scope of this specification. When the technical features of different embodiments are shown in the same figure, it may be regarded that this figure discloses the combinations of the various embodiments involved.

The above embodiments merely express several embodiments of the present application, and their descriptions are more specific and detailed, but should not be understood as limiting the scope of the patent application. It should be pointed out that for those ordinary skilled in the art, several modifications and may can be made without departing from the concept of this application, which are within the scope of protection of this application.

What is claimed is:

1. A chuck for a softbox, comprising:
a chunk body;
an adapter being rotatably assembled to the chunk body, wherein the adapter has an unfolded state and a folded state;
a plurality of connecting members configured for connecting support rods of the softbox, wherein the plurality of connecting members comprises multiple first connecting members being movably connected to the chunk body and multiple second connecting members being connected to the adapter; the plurality of connecting members extend radially when the adapter is in the unfolded state, a number of the second connecting members is less than half of a total number of the plurality of connecting members, and an orientation of the second connecting member when the adapter is in the unfolded state is opposite to that of the second connecting member when the adapter is in the folded state; and
a locking member configured for locking the adapter in the unfolded state.

2. The chuck of claim 1, wherein the adapter comprises a connecting portion that is rotatably connected to the chunk body and a mounting portion that fixes the second connecting member.

3. The chuck of claim 2, wherein the chunk body is configured with a recessed area, and when the adapter is in the unfolded state, the mounting portion is located in the recessed area and flushes with an outer circumferential surface of the chunk body, and the second connecting member protrudes out from the mounting portion.

4. The chuck of claim 2, wherein the adapter comprises a first holding portion, and the chunk body comprises a second holding portion arranged opposite to the first holding portion.

5. The chuck of claim 4, wherein the first holding portion extends between adjacent two second connecting members, and a gap is defined between the first holding portion and the mounting portion.

6. The chuck of claim 2, wherein the locking member comprises a locking portion and is slidably mounted to the chunk body, and has a locking state in which the locking portion is engaged with the mounting portion and an unlocking state in which the locking portion is disengaged from the mounting portion.

7. The chuck of claim 6, wherein the locking member comprises an unlocking portion.

8. The chuck of claim 7, wherein the locking member is slidable in a radial direction, and the unlocking portion is exposed outside an outer circumferential surface of the chunk body.

9. The chuck of claim 7, wherein the unlocking portion extends in a radial direction, the locking portion extends in an axial direction, and the mounting portion is configured with a locking hole that matches the locking portion.

10. The chuck of claim 2, further comprising a first reset member acting on the locking member to keep it in a locking state.

11. The chuck of claim 1, wherein the first connecting members are close to a middle position of the chunk body when the adapter is in the folded state.

12. The chuck of claim 1, wherein the chunk body is configured with a limiting groove extending along a circumferential direction, and the limiting groove is configured for limiting a motion trajectory of the first connecting member.

13. The chuck of claim 1, further comprising a second reset member acting on the first connecting member closest to the adapter to make it swing and unfold.

14. The chuck of claim 1, wherein the number of second connecting members is two.

15. The chuck of claim 1, wherein the number of first connecting members is six.

16. The flexible light box chuck according to claim 1, wherein the first connecting member comprises a mounting portion that cooperates with the chunk body in a rotatable manner, and a fixed portion that is fixed with the support rod by plug-in, the mounting portion is spherical-shaped, and the fixed portion is cylindrical-shaped and configured with a socket.

17. A softbox, comprising:
the chuck of claim 1;
a plurality of support rods connected to the first connecting members and the second connecting members; and
a reflective cloth supported by the plurality of support rods.
